(19) United States
(12) Patent Application Publication
(10) Pub. No.: US 2025/0378590 A1
(43) Pub. Date: Dec. 11, 2025

(54) Token Pruning for Image Generation

(71) Applicant: ADOBE INC., SAN JOSE, CA (US)

(72) Inventors: Yuchen Liu, Mountain View, CA (US); Hongjie Wang, Princeton, NJ (US); Difan Liu, San Jose, CA (US); Yan Kang, Kirkland, WA (US); Yijun Li, Seattle, WA (US); Zhe Lin, Clyde Hill, WA (US)

(21) Appl. No.: 18/736,340

(22) Filed: Jun. 6, 2024

(51) Int. Cl. G06T 11/00; G06T 5/70

(52) U.S. Cl. CPC G06T 11/00; G06T 5/70

(57) ABSTRACT

A method, apparatus, non-transitory computer readable medium, apparatus, and system for image processing include obtaining an input prompt; generating a plurality of tokens for an attention layer of a generative machine learning model based on an intermediate noise map; generating, using the attention layer, an attention map based on the plurality of tokens; pruning the plurality of tokens based on the attention map to obtain a pruned set of tokens; denoising the intermediate noise map based on the pruned set of tokens to obtain a denoised map; and generating a synthetic image based on the denoised map.

### BACKGROUND

The following relates generally to image processing, and more specifically to efficient image generation. Machine learning models may be used for a variety of image processing tasks including image editing and image generation. A variety of machine learning models may be used for image processing, including generative adversarial networks (GANs), variational auto-encoders (VAEs) and diffusion models. In some cases, machine learning models used for image processing may be computationally intensive. Therefore, there is a need in the art for more computationally efficient image processing models.

### SUMMARY

A method, apparatus, and non-transitory computer readable medium for image generation are described. One or more aspects of the method, apparatus, and non-transitory computer readable medium include obtaining an input prompt; generating a plurality of tokens for an attention layer of a generative machine learning model based on an intermediate noise map; generating, using the attention layer, an attention map based on the plurality of tokens; pruning the plurality of tokens based on the attention map to obtain a pruned set of tokens; denoising the intermediate noise map based on the pruned set of tokens to obtain a denoised map; and generating a synthetic image based on the denoised map.

A non-transitory computer readable medium storing code for a generative machine learning model is described. The code comprises instructions executable by at least one processor to obtain an input prompt; generate a plurality of tokens for an attention layer of the generative machine learning model based on intermediate noise map; generate, using the attention layer, an attention map based on the plurality of tokens; prune the plurality of tokens based on the attention map to obtain a pruned set of tokens; denoise, using the generative machine learning model, the intermediate noise map based on the pruned set of tokens to obtain a denoised map; and generate, using the generative machine learning model, a synthetic output based on the denoised map.

An apparatus and method for image generation are described. One or more aspects of the apparatus and method include at least one processor; at least one memory storing instruction executable by the at least one processor; and a generative machine learning model comprising parameters stored in the at least one memory and trained to generate, using an attention layer of the generative machine learning model, an attention map based on a plurality of tokens; prune the plurality of tokens based on the attention map to obtain a pruned set of tokens; denoise the intermediate noise map based on the pruned set of tokens to obtain a denoised map; and generate a synthetic output based on the denoised map.

### BRIEF DESCRIPTION OF THE DRAWINGS

FIG. 1 shows an example of an image processing system according to aspects of the present disclosure.

FIG. 2 shows an example of an image processing application according to aspects of the present disclosure.

FIG. 3 shows an example of an image processing system according to aspects of the present disclosure.

FIG. 4 shows an example of a method for adding replacement tokens according to aspects of the present disclosure.

FIG. 5 shows an example of an image processing apparatus according to aspects of the present disclosure.

FIG. 6 shows an example of a diffusion model according to aspects of the present disclosure.

FIG. 7 shows a method for image processing according to aspects of the present disclosure.

FIG. 8 shows a method for image processing according to aspects of the present disclosure.

FIG. 9 shows examples of feature maps and synthetic images according to aspects of the present disclosure.

FIG. 10 shows an example of an image processing device according to aspects of the present disclosure.

### DETAILED DESCRIPTION

The following relates generally to image processing, and more specifically to efficient image generation using diffusion models. Generative machine learning models have emerged as a powerful approach for generating high-quality and diverse images based on textual descriptions or input prompts. These generative machine learning models include diffusion models. The diffusion models generate synthetic images through a process including an iterative denoising process, where the models gradually refine the noisy input to produce a visually coherent and semantically relevant output. The computational cost and latency associated with generating images using diffusion models are notably high, particularly in real-time applications.

Embodiments of the present disclosure provide a method and apparatus for efficient image generation using diffusion models that leverage attention mechanisms to identify and prune less important tokens during the denoising process. The methods focus computational resources on the most salient aspects of the image by dynamically assigning importance scores to tokens based on attention maps generated by the self-attention layers within the diffusion model. Tokens with lower importance scores are pruned, effectively reducing the computational complexity of subsequent denoising steps without compromising the quality and diversity of the generated images.

Aspects of the present disclosure include a generalized weighted ranking algorithm to exploit the attention maps and assign importance scores to each token. The attention maps provide valuable insights into the relative importance of different tokens in the image generation process, enabling the method to make informed decisions about which tokens to prune. To maintain compatibility with the convolutional layers in the diffusion model and ensure the spatial coherence of the generated image, the methods utilize a similarity-based copy mechanism to recover the pruned tokens. This mechanism identifies the most similar retained tokens and copies their values to fill the positions of the pruned tokens, preserving the structural integrity of the generated image.

Embodiments of the disclosure improve the efficiency of image generation models while maintaining the quality and diversity of the generated images. For example, some embodiments achieve reductions in computational cost and latency by leveraging attention mechanisms to dynamically prune less important tokens during the denoising process. This focuses computational resources on the most salient aspects of the image, as determined by the attention maps generated by the attention layers. Moreover, an adaptive pruning strategy can be used to ensure that the generated images maintain structural integrity and visual quality, even under aggressive pruning settings. Experimental results demonstrate reduced computation while maintaining comparable image quality metrics.

Accordingly, a method for image generation is described. One or more aspects of the method include obtaining a plurality of tokens; generating, using an attention layer of a generative machine learning model, an attention map based on the plurality of tokens; pruning the plurality of tokens based on the attention map to obtain a pruned set of tokens; and generating, using the generative machine learning model, a synthetic output based on the pruned set of tokens.

Some examples of the method, apparatus, and non-transitory computer readable medium further include obtaining the pruned set of tokens comprises obtaining an input image; and encoding the input image to obtain the plurality of tokens, wherein the synthetic output comprises a synthetic image. Some examples of the method, apparatus, and non-transitory computer readable medium further include generating the attention map comprises performing a self-attention mechanism on the plurality of tokens.

Some examples of the method, apparatus, and non-transitory computer readable medium further include generating the attention map comprises performing a cross-attention mechanism on the plurality of tokens and a plurality of condition tokens. Some examples of the method, apparatus, and non-transitory computer readable medium further include pruning the plurality of tokens comprises computing an importance score for each of the plurality of tokens based on the attention map; and identifying a threshold importance score.

Some examples of the method, apparatus, and non-transitory computer readable medium further include generating the synthetic output comprises performing, using a subsequent attention layer of the generative machine learning model, an attention mechanism on the pruned set of tokens. Some examples of the method, apparatus, and non-transitory computer readable medium further include generating the synthetic output comprises identifying a plurality of pruned tokens; generating a plurality of replacement tokens corresponding to the plurality of pruned tokens; and adding the plurality of replacement tokens to the pruned set of tokens to obtain an augmented set of tokens.

Some examples of the method, apparatus, and non-transitory computer readable medium further include generating the synthetic output comprises performing a convolution based on the augmented set of tokens. Some examples of the method, apparatus, and non-transitory computer readable medium further include generating the plurality of replacement tokens comprises identifying a similarity-based copy for each of the plurality of replacement tokens.

Some examples of the method, apparatus, and non-transitory computer readable medium further include generating the synthetic output comprises performing a diffusion process on a noise input. Some examples of the method, apparatus, and non-transitory computer readable medium further include identifying a first pruning parameter, wherein the pruning is performed based on the first pruning parameter at a first stage of the generative machine learning model. Some examples further include identifying a second pruning parameter, wherein a subsequent pruning is performed based on the second pruning parameter at a second stage of the generative machine learning model.

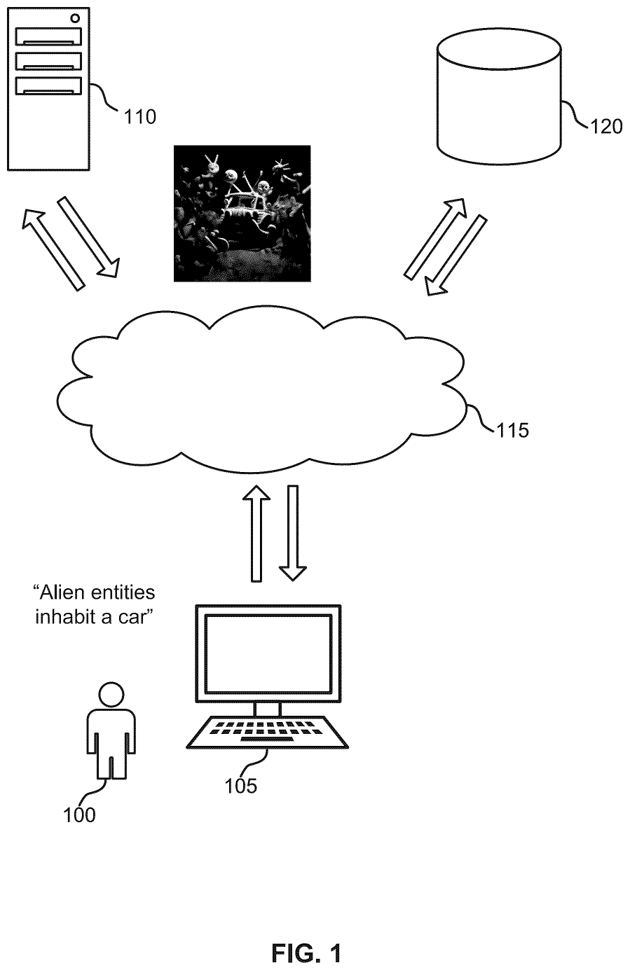

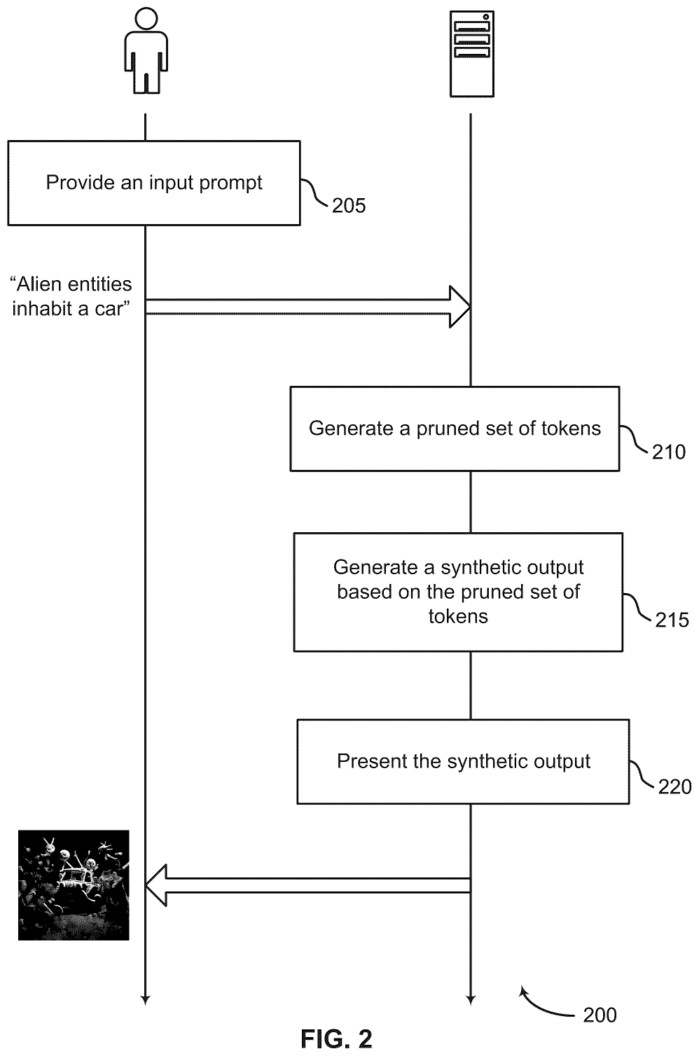

FIG. 1 shows an example of an image processing system according to aspects of the present disclosure. The image processing system is an example of, or includes aspects of, the corresponding element described with reference to FIGS. 2-6, 9, and 10.

In the example shown in FIG. 1, user 100 provides a text prompt to the image processing apparatus 110, e.g., via user device 105 and cloud 115. Image processing apparatus 110 then processes this text prompt using a pre-trained diffusion model to generate a high-quality image that corresponds to the given text description.

For example, the image processing apparatus 110 employs an Attention-driven Training-free Efficient Diffusion Model (AT-EDM) to enhance the efficiency of the image generation process. The diffusion model exploits the attention maps in the pre-trained diffusion model to identify and prune unimportant tokens, resulting in computational savings during the generation process.

For example, to maintain compatibility with the convolutional residual blocks in the diffusion model, the diffusion model employs a similarity-based copy mechanism to recover the pruned tokens. This mechanism identifies the most similar retained tokens and copies their values to fill the positions of the pruned tokens, ensuring the spatial completeness and coherence of the feature maps.

The adaptive pruning schedule adjusts the pruning strategy across different denoising steps. In the early steps, where the layout of the generated image is determined, fewer tokens are pruned to preserve important structural information. In the later steps, where the focus is on refining the image details, more aggressive pruning is applied to achieve higher computational savings.

The image processing apparatus 110 then generates high-quality images with improved efficiency, reduced computational complexity, and maintained image quality and text-image alignment. The resultant output image, depicting what is indicated by the text prompt, is then returned to user 100 via cloud 115 and user device 105, demonstrating the apparatus's capability to transform textual descriptions into visually appealing and semantically accurate images while achieving significant computational savings compared to traditional diffusion models.

User device 105 may be a personal computer, laptop computer, mainframe computer, palmtop computer, personal assistant, mobile device, or any other suitable processing apparatus. In some examples, user device 105 includes software that incorporates an image processing application (e.g., query answering, image editing, relationship detection). In some examples, the image editing application on user device 105 may include functions of image processing apparatus 110.

A user interface may enable user 100 to interact with user device 105. In some embodiments, the user interface may include an audio device, such as an external speaker system, an external display device such as a display screen, or an input device (e.g., a remote-control device interfaced with the user interface directly or through an I/O controller module). In some cases, a user interface may be a graphical user interface (GUI). In some examples, a user interface may be represented in code that is sent to the user device 105 and rendered locally by a browser. The process of using the image processing apparatus 110 is further described with reference to FIGS. 2-6, 9, and 10.

Image processing apparatus 110 includes a computer implemented network comprising an image encoder, a text encoder, a multi-modal encoder, and a decoder. Image processing apparatus 110 may also include a processor unit, a memory unit, an I/O module, and a training component. The training component is used to train a machine learning model (or an image processing network). Additionally, image processing apparatus 110 can communicate with database 120 via cloud 115. In some cases, the architecture of the image processing network is also referred to as a network, a machine learning model, or a network model. Further detail regarding the architecture of image processing apparatus 110 is provided with reference to FIGS. 2-6, 9, and 10.

In some cases, image processing apparatus 110 is implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

Database 120 is an organized collection of data. For example, database 120 stores data in a specified format known as a schema. Database 120 may be structured as a single database, a distributed database, multiple distributed databases, or an emergency backup database. In some cases, a database controller may manage data storage and processing in database 120. In some cases, a user interacts with the database controller. In other cases, database controllers may operate automatically without user interaction.

FIG. 2 shows an example of an image processing application 200 according to aspects of the present disclosure. The image processing application 200 is an example of, or includes aspects of, the corresponding element described with reference to FIGS. 1, 3-6, 9 and 10.

At operation 205, the user provides a prompt such as a text prompt or a reference image to the image processing apparatus. This prompt may be the input for the image processing system. The image processing system uses the prompt to generate a high-quality image that corresponds to the given text description while achieving computational efficiency.

At operation 210, the system generates a set of tokens representing an image (i.e., an image that is being generated by the image processing system). In some cases, the image processing system is a diffusion model, and the image is generated based on a noise map. During multiple denoising steps, noise is gradually removed to form an output image. At an internal attention block of the image processing system, a noise image (i.e., the input image for the attention block) is represented by a set of tokens. In some cases, each token represents an encoding of one or more pixels of the input image. The term ‘input image’ refers to the input to the attention block (e.g., a noise image or a representation of a noise image), as the input prompt used to generate the image may be a text prompt or some other prompt.

The image processing system prunes the set of tokens based on an attention map generated by the attention block. For example, a diffusion model performs token pruning within each denoising step. In some cases, the system obtains attention maps from the self-attention layers in the pre-trained diffusion model and employs a generalized weighted ranking algorithm to assign importance scores to each token based on the attention maps. Tokens with lower importance scores are then pruned to reduce computational complexity while preserving the most significant information for generating the target image.

At operation 215, the system generates a synthetic output based on the pruned set of token. In some examples, this process involves recovering the pruned tokens using a similarity-based copy mechanism to maintain compatibility with the convolutional residual blocks in the diffusion model. The system identifies the most similar retained tokens and copies their values to fill the positions of the pruned tokens, ensuring the spatial completeness and coherence of the feature maps. This process allows the diffusion model to generate high-quality images while operating on a reduced set of tokens, resulting in computational savings.

In some examples, the system employs an adaptive pruning schedule, which adapts the pruning strategy across different denoising steps. For example, the adaptive pruning schedule may apply less aggressive pruning in the early steps, where the layout of the generated image is determined, and more aggressive pruning in the later steps, where the focus is on refining the image details. This adaptive pruning approach ensures that the generated image maintains its structural integrity and visual quality while maximizing computational efficiency.

At operation 220, the image processing apparatus generates a synthetic image based on the text prompt, utilizing the system's token pruning and adaptive pruning schedule. The generated synthetic image is then presented to the user. The system enables the image processing apparatus to transform the textual description into a visually appealing and semantically accurate image while achieving significant computational savings compared to traditional diffusion models. The user can then assess and interact with the generated output, appreciating the improved efficiency and maintained image quality offered by the system.

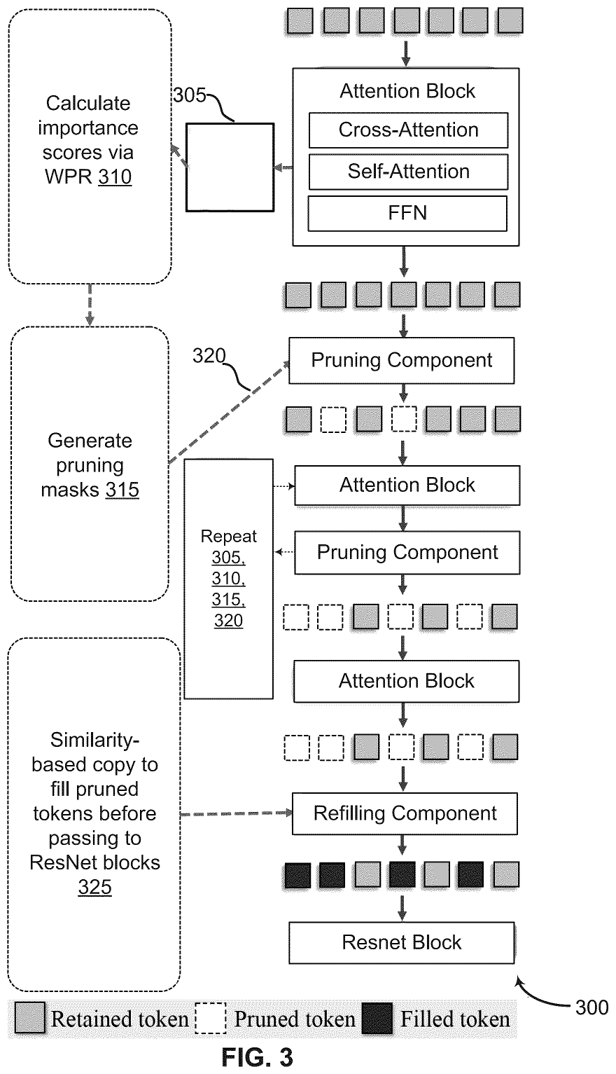

FIG. 3 shows an example of an image processing system 300 according to aspects of the present disclosure. The image processing system 300 is an example of, or includes aspects of, the corresponding element described with reference to FIGS. 1, 2, 4-6, 9, and 10.

In FIG. 3, the image processing system 300 includes an attention-driven and training-free model to generate synthetic images. The image processing system 300 may include a token pruning scheme applied within each denoising step of the diffusion process, and an adaptive pruning schedule across different denoising steps, such as a Denoising-Steps-Aware Pruning (DSAP) schedule. The token pruning scheme may include operations 305, 310, 315, and 320, which are performed sequentially within each denoising step. Operation 325 is executed before passing the pruned feature map to the convolutional residual block, such as a ResNet block.

Operation 305 includes obtaining attention maps. In operation 305, attention maps are obtained from an attention layer within the U-Net architecture of the diffusion model. The attention maps can be acquired from either the self-attention or cross-attention layers, depending on the specific implementation and the desired characteristics of the generated images.

Operation 310 involves calculating importance scores. In operation 310, a scoring module is employed to assign an importance score to each token based on the attention map obtained in operation 305. A ranking algorithm may be utilized to compute the importance scores, which quantify the significance of each token in the context of the generated image. The ranking algorithm may determine the importance of each token by considering its relationships with other tokens in the attention map, similar to an algorithm of ranking web pages based on their connections and importance within a network.

Operation 315 involves generating pruning masks. In Operation 315, pruning masks are generated based on the importance score distribution calculated in operation 310. For example, the implementation adopts a top-k approach, where tokens with lower importance scores are identified and selected for pruning.

Operation 320 involves applying pruning masks. In operation 320, the image processing system 300 applies the pruning masks generated in operation 315 to perform token pruning. This operation takes place after the feed-forward layer of the attention layers, effectively removing the less important tokens from the feature map.

According to some embodiments, a sequence of operations 305, 310, 315, and 320 may be repeated for each consecutive attention layer within the denoising step. In some examples, this iterative process allows for the progressive refinement of the feature map, focusing on the most important tokens and reducing computational overhead. In some embodiments, pruning is not applied to the last attention layer preceding the convolution layer, where the last attention layer preserves the spatial structure and information flow.

In some examples, a prune-less schedule may be employed in early denoising steps by leaving some of the layers unpruned. In some examples, each down-stage includes two attention blocks, and each up-stage includes three attention blocks, except for stages without attention. The mid-stage also includes one attention block. For example, each attention block includes 2 to 10 attention layers. In a prune-less schedule, some attention blocks may be selected not to perform token pruning. In some examples, the attention block in the mid stage is not selected. In some examples, the first attention block in each down-stage and the last attention block in each up-stage unpruned are left. The prune-less schedule may be used for the first t denoising steps and set τ=15.

Operation 325 involves recovering pruned tokens. Before passing the pruned feature map to the convolution block, operation 325 is performed to recover the pruned tokens and maintain the spatial structure of the feature map. In some embodiments, a similarity-based copy mechanism is employed to fill the pruned tokens. In some examples, the system identifies the most similar remaining tokens in the feature map and copies their information to the positions of the pruned tokens, effectively reconstructing the feature map while preserving its coherence and reducing computational complexity.

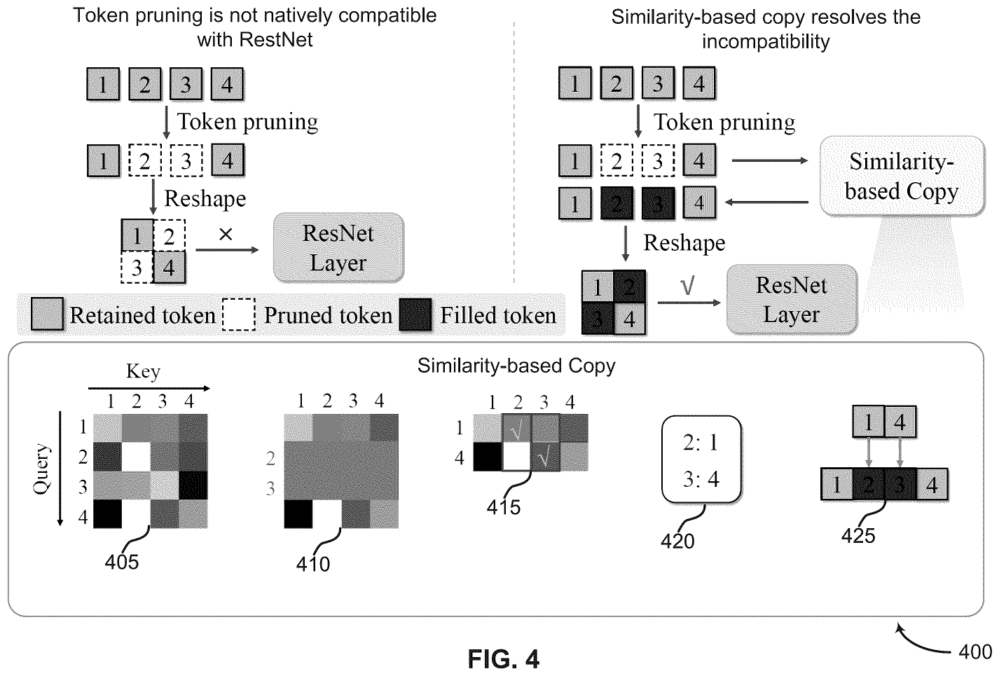

FIG. 4 shows an example of a method 400 for adding replacement tokens according to aspects of the present disclosure. The method 400 is an example of, or includes aspects of, the corresponding element described with reference to FIGS. 1-3, 5, 6, 9, and 10.

In FIG. 4, a similarity-based copy method for recovering pruned tokens is illustrated. Method 400 may be used to address the incompatibility between token pruning and convolutional residual blocks, such as ResNet. According to some embodiments, token pruning may result in non-square feature maps that are not compatible with ResNet. To resolve this issue, the similarity-based copy method recovers the pruned tokens through a series of operations.

In some embodiments, suppose A^{(h,l)}∈ [symbol] ^{M×N} is the attention map of the h-th head in the l-th layer, which reflects the correlations between Query tokens and N Key tokens. A^{(h,l)} can be denoted as A for simplicity in the following disclosure. Let A_{i,j} denote its element in the i-th row, j-th column. A can be considered as the adjacency matrix of a directed graph in the Generalized Weighted Page Rank (G-WPR) algorithm. In this directed graph, the set of nodes with input (output) edges is Φᵢₙ (Φₒᵤₜ). Nodes in Φᵢₙ (Φₒᵤₜ) represent Key (Query) tokens, i.e.,

$${Φ}_{i n} = {\{ {k}_{j} \}}_{j = 1}^{N} ( {Φ}_{out} = {\{ {q}_{i} \}}_{i = 1}^{M} ) .$$

### Let

$${s}_{K}^{t} ( {s}_{Q}^{t} )$$

denote the vector representing the importance score of Key (Query) tokens in the t-th iteration of the GWPR algorithm. In the case of self-attention, Query tokens are the same as Key tokens. Specifically, we let

$${\{ {x}_{i} \}}_{i = 1}^{N}$$

denote the N tokens and s denote the importance scores of them.

According to some embodiments, Weighted Page Rank (WPR) uses the attention map as an adjacency matrix of a directed, complete graph. WPR uses a graph signal to represent the importance score distribution among nodes in this graph. This signal may be initialized uniformly. WPR uses the adjacency matrix as a graph operator, applying it to the graph signal iteratively until convergence. In each iteration, each node votes for which node is more important. The weight of the vote is determined by its importance in the last iteration.

WPR restricts the utilized attention map to a self-attention map. Compared with WPR, G-WPR is compatible with both self-attention and cross-attention, as shown in Algorithm 1. The attention from Query qᵢ to Key kⱼ weights the edge from Query qᵢ to Key kⱼ in the graph generated by A. In each iteration of the vanilla WPR, by multiplying with the attention map, the importance of Query tokens

$${s}_{Q}^{t}$$

is mapped to the importance of Key tokens

$${s}_{K}^{t + 1} ,$$

i.e., each node in Φₒᵤₜ votes for which Φᵢₙ node is more important. For self-attention,

$${s}_{Q}^{t + 1} = {s}_{K}^{t + 1}$$

since Query and Key tokens are the same. For cross-attention, Query tokens are image tokens and Key tokens are text prompt tokens. In some examples, important image tokens may devote a large portion of their attention to important text prompt tokens. The function f(A,s_{K}) maps

$${s}_{K}^{t + 1} to {s}_{Q}^{t + 1} .$$

An entropy-based implementation is:

$${s}_{Q}^{t + 1} ( {q}_{i} ) = f ( A , {s}_{K}^{t + 1} ) = \frac{{Σ}_{j = I}^{N} {A}_{i , j} \cdot {s}_{K}^{t + 1} ( {k}_{j} )}{- {Σ}_{j = I}^{N} {A}_{i , j} \cdot {ln A}_{i , j}} \qquad ( 1 )$$

where A_{i,j} is the attention from Query qᵢ to Key kⱼ. This is an example setting for cross-attention-based WPR in the following disclosure. For self-attention,

$$f ( A , {s}_{K}^{t + 1} ) = {s}_{K}^{t + 1} .$$

This algorithm has an O(M×N) complexity, where M(N) is the number of Query (Key) tokens. This G-WPR algorithm may be employed in each head and the root mean square of scores from different heads may be obtained. This algorithm can be used to reward tokens that obtain very high importance scores in a few heads.

Algorithm 1 Generalized Weighted Page Rank (G-WPR) algorithm for
both self-attention and cross-attention

```
Require: M, N > 0 is the number of nodes in Φₒᵤₜ, Φᵢₙ; A ∈ [symbol]
^{M×N}; S_{Q} ∈ [symbol] ^{M}, S_{K} ∈ [symbol] ^{N}; ƒ(A, Sₖ) maps the importance of Key
  to that of Query
Ensure: s ∈ [symbol] ^{M} represents the importance score of image tokens
  ${s}_{Q}^{0} ← \frac{1}{M} \times {e}_{M}$
  t ← 0
  $while ( \vert {s}_{Q}^{t} - {s}_{Q}^{t - 1} \vert > ϵ ) or ( t = 0 ) do$
  $\begin{matrix}{s}_{K}^{t + 1} ← {A}^{T} \times {s}_{Q}^{t} \\ {s}_{Q}^{t + 1} ← f ( A , {s}_{K}^{t + 1} ) \\ {s}_{Q}^{t + 1} ← {s}_{Q}^{t + 1} / \vert {s}_{Q}^{t + 1} \vert\end{matrix}$
  t ← t + 1
  end while
$s ← {s}_{Q}^{t}$
```

In some examples, the pruned tokens are recovered to make the tokens compatible with the following convolutional operations in the ResNet layer. Some methods may involve using padding zeros. However, to maintain the high quality of generated images, these methods are not precise in terms of the values of the replacement tokens. Some methods may involve interpolation, such as bicubic interpolation. To utilize the interpolation algorithm, the system pad zeros to fill the pruned tokens and form a feature map with the size of N×N. Then the system downsamples the feature map to

$$\frac{N}{2} \times \frac{N}{2}$$

and upsample the feature map back to N×N with the interpolation algorithm. The values of retained tokens are fixed and only use the interpolated values of pruned tokens. Due to the high pruning rates, for example, larger than 50%, most tokens that represent the background get pruned, leading to lots of pruned tokens that are surrounded by other pruned tokens instead of retained tokens. In some examples, interpolation algorithms assign nearly zero values to these tokens. Some methods involve direct copy, e.g., using the corresponding values before pruning is applied (i.e., before being processed by following attention layers) to fill the pruned tokens. A problem with this method is that the value distribution changes significantly after being processed by multiple attention layers, and copied values are far from the values of these tokens if they are not pruned and are processed by the following attention layers.

According to some embodiments of the present disclosure, a similarity-based copy technique is provided. Instead of copying values that are not processed by attention layers, tokens that are similar to pruned tokens from the retained tokens are selected as replacement tokens. The self-attention map may be used to determine the source of the highest attention received for each pruned token and use that as the most similar one. In some examples, attention from token xₐ to token x_{b}, A_{a,b}, is determined by importance of token x_{b}, i.e., s(x_{b}) and similarity between token xₐ and x_{b}. In some examples, by comparing the attention that x_{b} receives, i.e., comparing {A_{i,b}}_{i∈N}, and considering that s(x_{b}) is fixed, index i=ρ that maximizes {A_{i,b}}_{i∈N} is the index of the most similar token, i.e., x_{ρ}. Accordingly, the value of token x_{ρ} may be copied to fill (i.e., recover) the pruned token x_{b}.

Referring to FIG. 4, operation 405 involves obtaining the attention map averaged across different attention heads. This step may ensure that the attention map captures the overall importance of tokens across multiple heads, providing a more comprehensive representation of token relationships.

In Operation 410, the rows corresponding to the pruned tokens are deleted from the averaged attention map. This step prevents the pruned tokens from being selected as the most similar tokens during the recovery process, as they have been deemed less important and removed from the feature map.

Operation 415 focuses on finding the source of the highest attention received for each pruned token. By identifying the token that provides the most significant attention to each pruned token, this operation determines the most similar retained token for each pruned token.

In Operation 420, the most similar retained token is identified for each pruned token based on the highest attention received, as determined in Operation 415. This step establishes a mapping between the pruned tokens and their most similar counterparts among the retained tokens.

Operation 425 involves copying the values of the most similar retained tokens to fill the positions of the pruned tokens in the feature map. By replacing the pruned tokens with the values of their most similar retained tokens, the feature map is reconstructed, preserving its spatial completeness and coherence.

After the similarity-based copy method recovers the pruned tokens, the resulting feature map has a square shape and can be effectively processed by the subsequent convolutional residual blocks, such as ResNet. This ensures that the token pruning approach remains compatible with the overall architecture of the diffusion model, maintaining the quality of the generated images while achieving computational efficiency through token pruning.

The G-WPR algorithm, as described in Algorithm 1, is employed to calculate the importance scores of tokens based on the attention maps. In some examples, the G-WPR algorithm is compatible with both self-attention and cross-attention mechanisms, In some examples, the G-WPR algorithm is versatile and adaptable to different diffusion model architectures.

Some non-transitory computer readable medium storing code for a generative machine learning model is described. The code comprising instructions executable by at least one processor to obtain a plurality of tokens; generating, using an attention layer of the generative machine learning model, an attention map based on the plurality of tokens; prune the plurality of tokens based on the attention map to obtain a pruned set of tokens; and generate, using the generative machine learning model, a synthetic output based on the pruned set of tokens.

In some aspects, pruning the plurality of tokens comprises: computing an importance score for each of the plurality of tokens based on the attention map; and identifying a threshold importance score. In some aspects, generating the synthetic output comprises: identifying a plurality of pruned tokens; generating a plurality of replacement tokens corresponding to the plurality of pruned tokens; and adding the plurality of replacement tokens to the pruned set of tokens to obtain an augmented set of tokens.

An apparatus for image generation is described. One or more aspects of the apparatus include at least one processor; at least one memory storing instruction executable by the at least one processor; a generative machine learning model comprising parameters stored in the at least one memory and trained to: ; generating, using an attention layer of the generative machine learning model, an attention map based on a plurality of tokens; pruning the plurality of tokens based on the attention map to obtain a pruned set of tokens; and generating a synthetic output based on the pruned set of tokens.

In some aspects, the generative machine learning model comprises a diffusion model. Some examples of the apparatus and method further include a text encoder configured to generate a plurality of condition tokens. In some aspects, the generative machine learning model comprises an attention block comprising the attention layer and a subsequent attention layer that processes the pruned set of tokens.

In some aspects, the generative machine learning model comprises a convolution layer that processes an augmented set of tokens including the pruned set of tokens and a plurality of replacement tokens. In some aspects, the generative machine learning model comprises a pre-trained model that is not fine-tuned prior to generating the synthetic output.

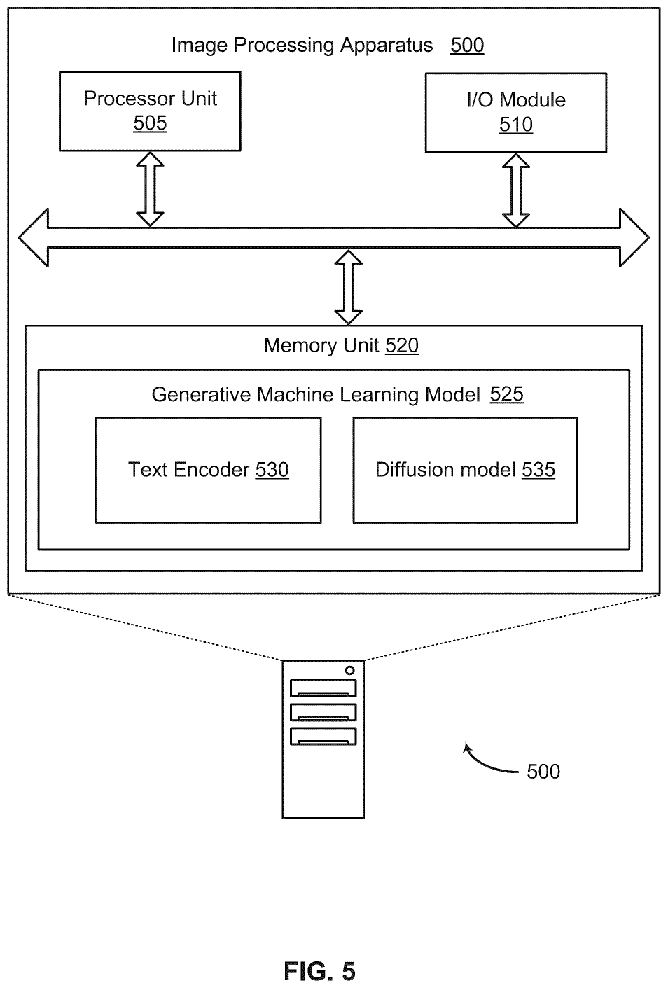

FIG. 5 shows an example of an image processing apparatus 500 according to aspects of the present disclosure. image processing apparatus 500 is an example of, or includes aspects of, the corresponding element described with reference to FIGS. 1-4, 6, 9, and 10. In one aspect, image processing apparatus 500 includes processor unit 505, I/O module 510, memory unit 520, generative machine learning model 525 including text encoder 530 and diffusion model 535.

Processor unit 505 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 505 is configured to operate a memory array using a memory controller. In other cases, a memory controller is integrated into processor unit 505. In some cases, processor unit 505 is configured to execute computer-readable instructions stored in memory unit 520 to perform various functions. In some aspects, processor unit 505 includes special purpose components for modem processing, baseband processing, digital signal processing, or transmission processing. According to aspects, processor unit 505 comprises one or more processors described with reference to FIGS. 1-4, 6, 9, and 10.

Memory unit 520 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 505 to perform various functions described herein.

In some cases, memory unit 520 includes a basic input/output system (BIOS) that controls basic hardware or software operations, such as an interaction with peripheral components or devices. In some cases, memory unit 520 includes a memory controller that operates memory cells of memory unit 520. For example, the memory controller may include a row decoder, column decoder, or both. In some cases, memory cells within memory unit 520 store information in the form of a logical state. According to aspects, memory unit 520 comprises the memory subsystem described with reference to FIGS. 1-4, 6, 9, and 10.

According to aspects, image processing apparatus 500 uses one or more processors of processor unit 505 to execute instructions stored in memory unit 520 to perform functions described herein. For example, in some cases, the image processing apparatus 500 obtains a prompt describing an image element. For example, the image element may correspond to a plurality of concepts.

Machine learning parameters, also known as model parameters or weights, are variables that provide a behavior and characteristics of a machine learning model. Machine learning parameters can be learned or estimated from training data and are used to make predictions or perform tasks based on learned patterns and relationships in the data.

Machine learning parameters are typically adjusted during a training process to minimize a loss function or maximize a performance metric. The goal of the training process is to find optimal values for the parameters that allow the machine learning model to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

Artificial neural networks (ANNs) have numerous parameters, including weights and biases associated with each neuron in the network, which control a degree of connections between neurons and influence the neural network's ability to capture complex patterns in data.

An ANN is a hardware component or a software component that includes a number of connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

In some cases, the signals between nodes comprise real numbers, and the output of each node is computed by a function of the sum of its inputs. In some examples, nodes may determine their output using other mathematical algorithms, such as selecting the max from the inputs as the output, or any other suitable algorithm for activating the node. Each node and edge are associated with one or more node weights that determine how the signal is processed and transmitted.

In ANNs, a hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

During a training process of an ANN, the node weights are adjusted to improve the accuracy of the result (i.e., by minimizing a loss which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

The generative machine learning model 525 in the image processing apparatus may be configured to generate synthetic images. In some examples, the generative machine learning model 525 includes an attention layer that can be configured to create an attention map from a variety of tokens. This attention map helps the model to identify and focus on the most relevant parts of the input data, facilitating the pruning process where less significant tokens are removed, resulting in a pruned set of tokens. The generative machine learning model 525 then uses these pruned tokens to generate a synthetic output, such as an image. In some examples, the generative machine learning model 525 includes a diffusion model, enabling the generative machine learning model 525 to generate high-quality images through a process that iteratively refines the image output by adding and controlling noise levels.

The generative machine learning model 525 includes the text encoder 530 configured to convert textual input into a series of condition tokens. These tokens are used to provide contextual or conditional information to the generative model, guiding the image generation process in a way that aligns with the textual description. The text encoder 530 can be used to create images that are closely related to the provided text descriptions, making the generative process more directed and specific.

The generative machine learning model 525 includes the diffusion model 535. The diffusion model 535 operates by gradually transforming a random noise pattern into a coherent image output, based on the pruned set of tokens and the guidance provided by the attention maps. This transformation may take place over multiple steps, allowing for detailed and controlled generation of images.

In some examples, the generative machine learning model 525 includes an attention block that includes both the initial attention layer and a subsequent attention layer, which processes the pruned set of tokens to refine the focus and detail of the generated image. The attention block may also have a convolution layer that processes an augmented set of tokens, which includes both the pruned set of tokens and a series of replacement tokens, adding further detail and complexity to the generated image. According to some embodiments, the generative machine learning model 525 operates without the need for fine-tuning prior to generating the synthetic output.

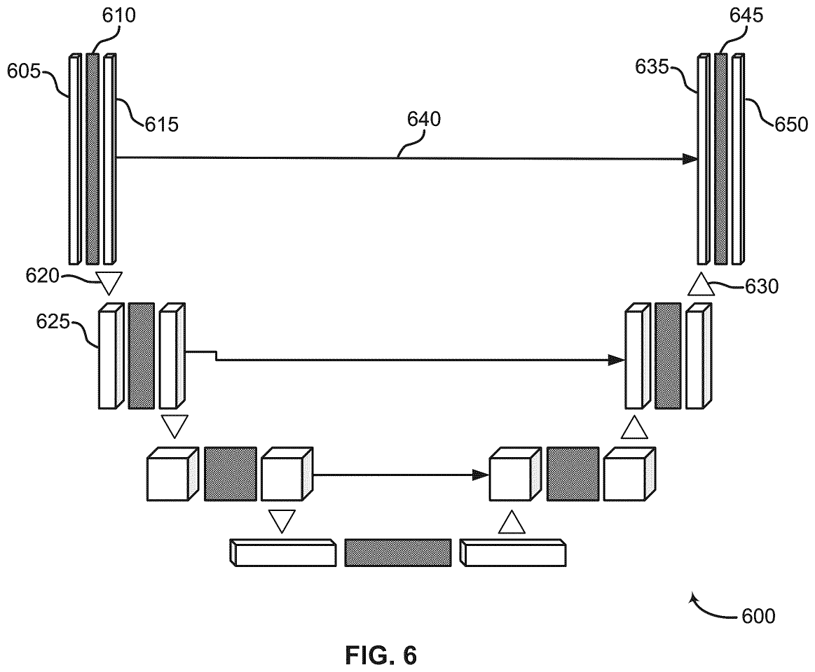

FIG. 6 shows an example of diffusion model 600 according to aspects of the present disclosure. The diffusion model 600 is an example of, or includes aspects of, the corresponding element described with reference to FIGS. 1-5, 9, and 10.

According to some aspects, diffusion model 600 receives input features 605, where input features 605 include an initial resolution and an initial number of channels, and processes input features 605 using an initial neural network layer 610 (e.g., a convolutional neural network layer) to produce intermediate features 615.

In some cases, intermediate features 615 are then down-sampled using a down-sampling layer 620 such that down-sampled features 625 have a resolution less than the initial resolution and a number of channels greater than the initial number of channels.

In some cases, this process is repeated multiple times, and then the process is reversed. For example, down-sampled features 625 are up-sampled using up-sampling process 630 to obtain up-sampled features 635. In some cases, up-sampled features 635 are combined with intermediate features 615 having the same resolution and number of channels via skip connection 640. In some cases, the combination of intermediate features 615 and up-sampled features 635 are processed using final neural network layer 645 to produce output features 650. In some cases, output features 650 have the same resolution as the initial resolution and the same number of channels as the initial number of channels.

According to some aspects, diffusion model 600 receives additional input features to produce a conditionally generated output. In some cases, the additional input features include a vector representation of an input prompt. In some cases, the additional input features are combined with intermediate features 615 within Diffusion model 600 at one or more layers. For example, in some cases, a cross-attention module is used to combine the additional input features and intermediate features 615.

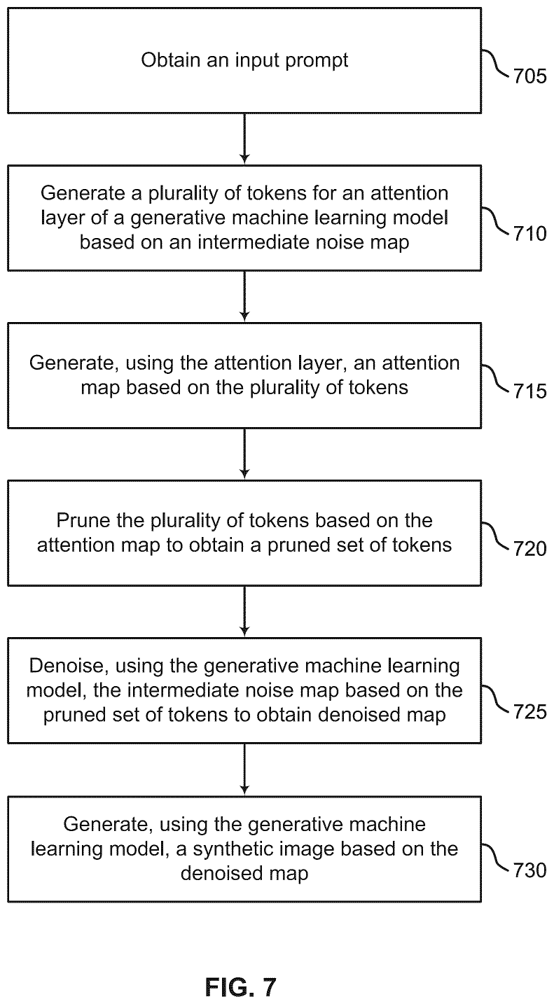

FIG. 7 shows an example of a method 700 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 705, the system obtains an input prompt. In some cases, the operations of this step refer to, or may be performed by, a generative machine learning model as described with reference to FIGS. 3-6 and 10.

For example, at operation 705, the input prompt may be provided by a user to indicate a target synthetic image. The input prompt may describe visual content and visual features of the target synthetic image. In some examples, the user is a human user. In some examples, the user can be a computer system, application, or service.

At operation 710, the system generates a plurality of tokens for an attention layer of a generative machine learning model based on an intermediate noise map. In some cases, the operations of this step refer to, or may be performed by, a generative machine learning model as described with reference to FIGS. 3-6 and 10.

For example, operation 710 involves obtaining a set of tokens for an attention layer of the generative machine learning model. The set of tokens may be further processed by the generative machine learning model. For example, each of the tokens may correspond to a region of an image corresponding to the input prompt, and capture the local visual information and features of that region. The generative machine learning model may encode input images to generate the set of tokens. The quality and relevance of these tokens may impact the model's ability to generate accurate and coherent outputs. In operation 705, the system may preprocess or normalize the data to ensure that it is in a suitable format for the model to process effectively, laying the foundation for the subsequent operations in the generative process.

The term “tokens” refer to segments or regions within the feature map of the embedded image. For example, the tokens may be learned representations of image patches that are derived during the diffusion process. For example, each token encapsulates information about areas of the image, potentially including groups of pixels that together form recognizable patterns, textures, or other visual elements. For example, the set of tokens represent pixels aggregated features that convey more complex information about the image's content.

For example, in operation 705, obtaining a set of tokens includes obtaining an input image and encoding this image to obtain the plurality of tokens. For example, this process involves transforming the visual content of the image into a form that the generative machine learning model can process, effectively translating pixels and visual features into a structured format of tokens. These tokens may be further processed by the generative machine learning model in the later stages of the diffusion process.

At operation 715, the system generates, using an attention layer, an attention map based on the set of tokens. In some cases, the operations of this step refer to, or may be performed by, an attention block as described with reference to FIGS. 3-6 and 10.

For example, at operation 715, the generative machine learning model utilizes an attention layer to analyze the tokens obtained in operation 705. In some examples, this attention layer helps the model to focus on specific parts of the input that are more relevant for generating the output. The attention layer may enable the creation of an attention map, where the attention map assigns different weights to the tokens, indicating the tokens' relative importance. In some examples, the attention mechanism enables the model to dynamically allocate more processing power to significant tokens, improving the model's ability to capture complex relationships and nuances in the data. In some examples, the attention mechanism allows the models to deal with large and complex datasets. For example, the attention mechanism enhances the model's ability to discern and prioritize the most pertinent information for the task at hand.

For example, in operation 715, generating the attention map includes performing a self-attention mechanism on the plurality of tokens. This self-attention mechanism enables the model to evaluate each token in the context of others within the same set, allowing the model to identify and emphasize the relationships and dependencies among the tokens. This process enhances the model's understanding of the data's intrinsic structure, facilitating a more nuanced and detailed generation process.

For example, in operation 715, generating the attention map involves performing a cross-attention mechanism on the plurality of tokens and a plurality of condition tokens. This cross-attention mechanism allows the model to process the tokens in relation to an additional set of tokens, such as condition tokens. The condition tokens can provide external contextual information or constraints, further guiding the model's focus and improving its output accuracy and relevance.

At operation 720, the system prunes the set of tokens based on the attention map to obtain a pruned set of tokens. In some cases, the operations of this step refer to, or may be performed by, a generative machine learning model as described with reference to FIGS. 3-6 and 10.

For example, in operation 720, the system prunes the tokens based on the attention map generated in operation 715. This pruning process involves discarding tokens that have lower importance scores according to the attention map, thereby streamlining the dataset before it is fed into the next stage of the model. In some examples, operation 720 helps to reduce the computational complexity and improve the efficiency of the model by focusing on a smaller, more relevant set of tokens. In some examples, operation 720 leverages the insights gained from the attention mechanism to ensure that the generative model concentrates on processing the most critical information, which can lead to more accurate and effective generation of outputs.

For example, in operation 720, pruning the plurality of tokens involves computing an importance score for each of the tokens based on the attention map and identifying a threshold importance score. Tokens with importance scores below this threshold are considered less relevant and are pruned from the set, ensuring that only the most significant tokens are retained for generating the final output. This selective pruning helps to optimize the model's performance by concentrating its computational resources on the most impactful data elements.

At operation 725, the system denoises the intermediate noise map based on the pruned set of tokens to obtain a denoised map. In some cases, the operations of this step refer to, or may be performed by, a generative machine learning model as described with reference to FIGS. 3-6 and 10.

For example, the system applies the diffusion model's denoising function to the intermediate noise map, using the pruned set of tokens as input. The denoising function learns to map the noisy token representations to their denoised counterparts, removing the noise and refining the image content. In some examples, this process leverages the learned patterns and relationships captured by the diffusion model to generate a more coherent and visually appealing denoised map. The resulting denoised map may be used as the input for the next iteration of the diffusion process, where the system continues to refine the image using the updated token representations. In these examples, by iteratively applying the denoising function to the pruned set of tokens across multiple diffusion steps, the system gradually transforms the initial noisy input into a synthetic image indicated by the input prompt.

At operation 730, the system generates, using the generative machine learning model, a synthetic image based on the denoised map. In some cases, the operations of this step refer to, or may be performed by, a generative machine learning model as described with reference to FIGS. 3-6 and 10.

For example, operation 730 involves the generation of the synthetic image using the denoised map. At operation 720, the generative machine learning model leverages the trained parameters to process the refined input and create an output that is a synthetic representation of the input data. This output includes a synthetic image.

For example, at operation 730, updated tokens are used to generate a denoised map at the current diffusion step. The diffusion model iteratively refines the noisy input image by operating on the token representations and updating them based on the learned patterns and relationships. This process may be repeated for a number of denoising steps. The denoised map at each step may be the input for the next step in the diffusion process until the final output image is generated.

For example, in operation 730, generating the synthetic image includes performing an attention mechanism on the pruned set of tokens, using a subsequent attention layer of the generative machine learning model. This attention mechanism further refines the model's focus, allowing the model to concentrate on the most relevant features of the pruned tokens. By using the attention mechanism, the model synthesizes an output that is a coherent and contextually relevant representation of the original input.

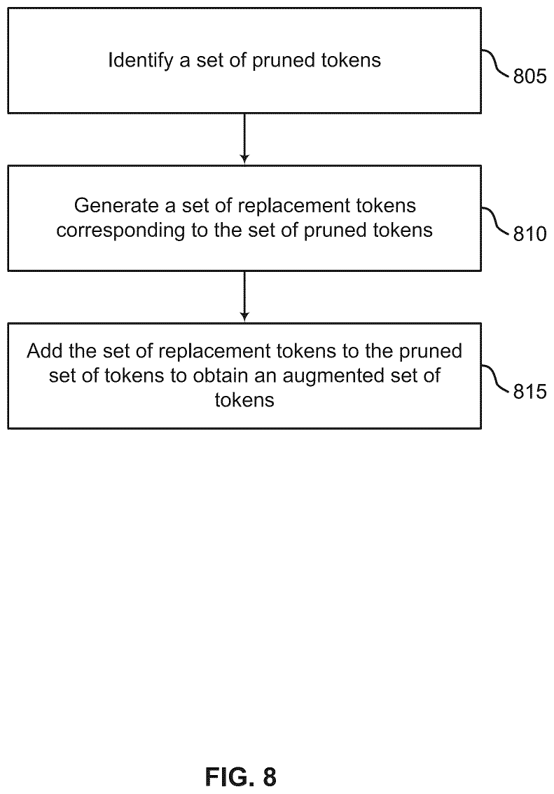

FIG. 8 shows an example of a method 800 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 805, the system identifies a set of pruned tokens. In some cases, the operations of this step refer to, or may be performed by, a generative machine learning model as described with reference to FIGS. 3-6 and 10.

For example, in operation 805, the generative machine learning model filters out less relevant or less significant tokens from the initial set. For example, this operation refines the focus of the model, enabling the model to concentrate on the pertinent elements of the data. In some examples, operation 805 involves isolating tokens that represent crucial features of the image, such as distinct objects or important textures, and discarding those that contribute less to the overall composition or meaning of the image.

At operation 810, the system generates a set of replacement tokens corresponding to the set of pruned tokens. In some cases, the operations of this step refer to, or may be performed by, a generative machine learning model as described with reference to FIGS. 3-6 and 10.

For example, in operation 810, the system generates a set of replacement tokens corresponding to the set of pruned tokens. In some examples, operation 810 involves identifying a similarity-based copy for each of the replacement tokens. For example, when the pruned tokens represent specific features or patterns in an image, the system generates replacement tokens that closely match or complement these features. In some examples, this process ensures that the essential characteristics of the original data are preserved, after pruning, by replacing the removed tokens with similar or contextually appropriate alternatives.

At operation 815, the system adds the set of replacement tokens to the pruned set of tokens to obtain an augmented set of tokens. In some cases, the operations of this step refer to, or may be performed by, a generative machine learning model as described with reference to FIGS. 3-6 and 10.

For example, in operation 815, the system adds the set of replacement tokens to the pruned set of tokens to obtain an augmented set of tokens. This augmented set combines the refined focus of the pruned tokens with the fresh perspectives or complementary details introduced by the replacement tokens. For example, in the context of image generation, this operation would result in a more comprehensive and detailed set of tokens that encapsulate both the core and nuanced features of the image, setting the stage for a more detailed and accurate synthesis process.

In some examples, the system performs a convolution based on the augmented set of tokens and a diffusion process on a noise input. In the convolution operation, the augmented set of tokens is processed to create a detailed and coherent feature map, integrating the various elements represented by the tokens. This feature map serves as the basis for the final image synthesis, where the diffusion process introduces a controlled amount of noise to the system, enabling the model to iteratively refine and generate the final image output. According to some embodiments, this process combines the structured information provided by the tokens with the generative flexibility of the diffusion process, leading to a synthetic output that is both detailed and dynamically generated.

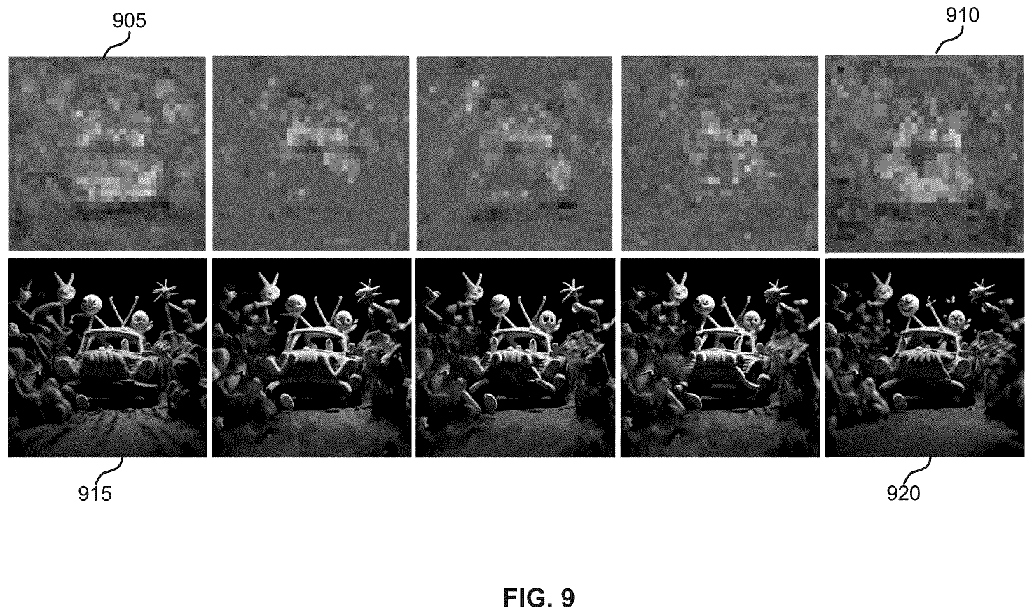

FIG. 9 shows an example of examples 900 of feature maps and synthetic images according to aspects of the present disclosure. The examples 900 are an example of, or include aspects of, the corresponding element described with reference to FIGS. 1-6, and 10.

FIG. 9 illustrates a visual comparison of the feature maps and synthetic images generated by the framework for efficient generation of images using diffusion models, such as the Attention-driven Training-free Efficient Diffusion Models (AT-EDM), and some methods serving as a control group. Examples 900 demonstrate the superior results and effects achieved by the framework in comparison to the traditional approach.

Referring to FIG. 9, control feature map 905 represents the feature map generated by some methods, which serves as a baseline for comparison. Control feature map 905 is used to generate the corresponding control image 910, which is the synthetic image produced by the traditional method. This method operates under a similar floating-point operations (FLOPs) budget as the framework, where FLOPs are a measure of the computational complexity of a model, representing the number of arithmetic operations performed.

Feature map 915 is a feature map generated by the framework according to embodiments of the present disclosure, such as the attention-driven and training-free efficient diffusion models, which incorporates the token pruning scheme and the adaptive pruning schedule across different denoising steps. Feature map 915 may be obtained by exploiting the attention maps in pre-trained diffusion models to identify and prune unimportant tokens, resulting in computational savings during the generation process while maintaining a similar FLOPs budget as the traditional method.

The synthetic image 920 is the generated image corresponding to feature map 915, produced by the framework. The synthetic image 920 exhibits several advantages and superior effects compared to the control image 910 generated by the traditional method, while operating under a similar FLOPs budget.

In some examples, a notable advantage of the synthetic image 920 is its improved image quality, as measured by the Fréchet Inception Distance (FID) score. The FID score measures the similarity between the distribution of generated images and the distribution of real images, with lower scores indicating better image quality and diversity. The framework effectively preserves the important tokens and recovers the pruned tokens using the similarity-based copy mechanism, resulting in a generated image with enhanced visual fidelity and clarity, as evidenced by a lower FID score compared to the control image 910.

In some examples, a notable advantage of the synthetic image 920 is the improved text-image alignment, as evaluated by the Contrastive Language-Image Pre-training (CLIP) score. The CLIP score measures the alignment between the generated image and the corresponding text prompt, with higher scores suggesting better text-image alignment. The framework leverages the attention maps to capture the relationships between image tokens and text prompt tokens, ensuring that the generated image accurately reflects the semantic content of the text prompt. This results in a stronger correlation between the visual elements in the synthetic image and the corresponding textual description, as demonstrated by a higher CLIP score compared to the control image 910.

FIG. 9 thus demonstrates the superior performance and advantages of the framework for efficient generation of images using diffusion models over some methods in a control group, while operating under similar FLOPs budgets. The synthetic image generated by the framework exhibits improved image quality, as measured by the FID score, and enhanced text-image alignment, as evaluated by the CLIP score, making it a highly effective and efficient approach for image generation tasks.

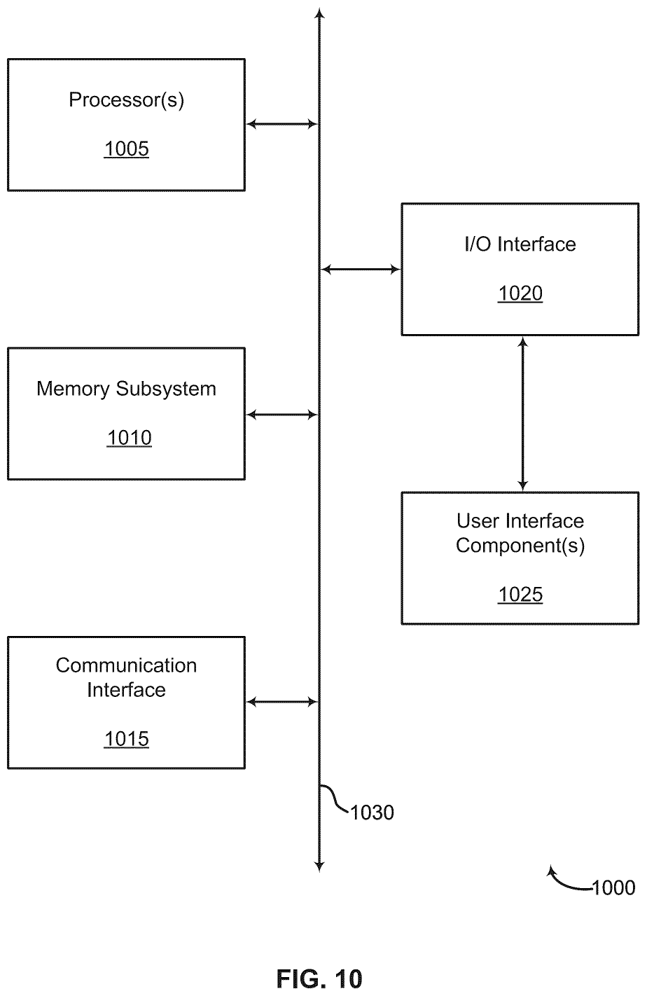

FIG. 10 shows an example of a computing device 1000 device according to aspects of the present disclosure. The computing device 1100 includes processor(s) 1005, memory subsystem 1010, communication interface 1015, I/O interface 1020, user interface component(s) 1025, and channel 1030. The computing device 1000 is an example of, or includes aspects of, the corresponding element described with reference to FIGS. 1-6, and 9.

According to some aspects, computing device 1000 includes one or more processors 1005. Processor(s) 1005 are an example of, or includes aspects of, the processor unit as described with reference to FIG. 5. In some cases, a processor is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or a combination thereof.

In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special-purpose components for modem processing, baseband processing, digital signal processing, or transmission processing.

According to some aspects, memory subsystem 1010 includes one or more memory devices. Memory subsystem 1010 is an example of, or includes aspects of, the memory unit as described with reference to FIG. 5. Examples of a memory device include random access memory (RAM), read-only memory (ROM), or a hard disk. Examples of memory devices include solid-state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operations such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1015 operates at a boundary between communicating entities (such as computing device 1000, one or more user devices, a cloud, and one or more databases) and channel 1030 and can record and process communications. In some cases, communication interface 1015 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1020 is controlled by an I/O controller to manage input and output signals for computing device 1000. In some cases, I/O interface 1020 manages peripherals not integrated into computing device 1000. In some cases, I/O interface 1020 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1020 or via hardware components controlled by the I/O controller.

According to some aspects, user interface component 1025 enables a user to interact with computing device 1000. In some cases, user interface component 1025 includes an audio device, such as an external speaker system, an external display device such as a display screen, an input device (e.g., a remote-control device interfaced with a user interface directly or through the I/O controller), or a combination thereof. In some cases, user interface component 1025 includes a GUI.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an input prompt;
generating a plurality of tokens for an attention layer of a generative machine learning model based on an intermediate noise map;
generating, using the attention layer, an attention map based on the plurality of tokens;
pruning the plurality of tokens based on the attention map to obtain a pruned set of tokens;
denoising, using the generative machine learning model, the intermediate noise map based on the pruned set of tokens to obtain a denoised map; and
generating, using the generative machine learning model, a synthetic image based on the denoised map.

2. The method of claim 1, wherein:
each of the plurality of tokens corresponds to one or more pixels of an image.

3. The method of claim 1, wherein generating the attention map comprises:
performing a self-attention mechanism on the plurality of tokens.

4. The method of claim 1, wherein generating the attention map comprises:
performing a cross-attention mechanism on the plurality of tokens and a plurality of condition tokens.

5. The method of claim 1, wherein pruning the plurality of tokens comprises:
computing an importance score for each of the plurality of tokens based on the attention map; and
identifying a threshold importance score.

6. The method of claim 1, wherein generating the synthetic output comprises:
performing, using a subsequent attention layer of the generative machine learning model, an attention mechanism on the pruned set of tokens.

7. The method of claim 1, wherein generating the synthetic output comprises:
identifying a plurality of pruned tokens;
generating a plurality of replacement tokens corresponding to the plurality of pruned tokens; and
adding the plurality of replacement tokens to the pruned set of tokens to obtain an augmented set of tokens.

8. The method of claim 7, wherein generating the synthetic output comprises:
performing a convolution based on the augmented set of tokens.

9. The method of claim 7, wherein generating the plurality of replacement tokens comprises:
identifying a similarity-based copy for each of the plurality of replacement tokens.

10. The method of claim 1, wherein generating the synthetic output comprises:
performing a diffusion process on a noise input.

11. The method of claim 1, further comprising:
identifying a first pruning parameter, wherein the pruning is performed based on the first pruning parameter at a first stage of the generative machine learning model; and
identifying a second pruning parameter, wherein a subsequent pruning is performed based on the second pruning parameter at a second stage of the generative machine learning model.

12. A non-transitory computer readable medium storing code for a generative machine learning model, the code comprising instructions executable by at least one processor to:
obtain an input prompt;
generate a plurality of tokens for an attention layer of the generative machine learning model based on intermediate noise map;
generate, using the attention layer, an attention map based on the plurality of tokens;
prune the plurality of tokens based on the attention map to obtain a pruned set of tokens;
denoise, using the generative machine learning model, the intermediate noise map based on the pruned set of tokens to obtain a denoised map; and
generate, using the generative machine learning model, a synthetic output based on the denoised map.

13. The non-transitory computer readable medium of claim 12, wherein pruning the plurality of tokens comprises:
computing an importance score for each of the plurality of tokens based on the attention map; and
identifying a threshold importance score.

14. The non-transitory computer readable medium of claim 12, wherein generating the synthetic output comprises:
identifying a plurality of pruned tokens;
generating a plurality of replacement tokens corresponding to the plurality of pruned tokens; and
adding the plurality of replacement tokens to the pruned set of tokens to obtain an augmented set of tokens.

15. An apparatus comprising:
at least one processor;
at least one memory storing instruction executable by the at least one processor; and
a generative machine learning model comprising parameters stored in the at least one memory and trained to:
generate, using an attention layer of the generative machine learning model, an attention map based on a plurality of tokens;
prune the plurality of tokens based on the attention map to obtain a pruned set of tokens;
denoise the intermediate noise map based on the pruned set of tokens to obtain a denoised map; and
generate a synthetic output based on the denoised map.

16. The apparatus of claim 15, wherein:
the generative machine learning model comprises a diffusion model.

17. The apparatus of claim 15, further comprising:
a text encoder configured to generate a plurality of condition tokens.

18. The apparatus of claim 15, wherein:
the generative machine learning model comprises an attention block comprising the attention layer and a subsequent attention layer that processes the pruned set of tokens.

19. The apparatus of claim 15, wherein:
the generative machine learning model comprises a convolution layer that processes an augmented set of tokens including the pruned set of tokens and a plurality of replacement tokens.

20. The apparatus of claim 15, wherein:
the generative machine learning model comprises a pre-trained model that is not fine-tuned prior to generating the synthetic output.
